(19) United States
(12) Patent Application Publication
(10) Pub. No.: US 2025/0108636 A1
(43) Pub. Date: Apr. 3, 2025

(54) PLATEN, LIQUID DISCHARGE APPARATUS, AND FIXING MEMBER

(71) Applicants: Yuka MIYABE, KANAGAWA (JP); Masanori HIRANO, KANAGAWA (JP)

(72) Inventors: Yuka MIYABE, KANAGAWA (JP); Masanori HIRANO, KANAGAWA (JP)

(21) Appl. No.: 18/896,983

(22) Filed: Sep. 26, 2024

(30) Foreign Application Priority Data
Sep. 29, 2023 (JP) 2023-170021

(51) Int. Cl. B41J 11/06; B41J 3/407

(52) U.S. Cl. CPC B41J 11/06; B41J 3/4078

(57) ABSTRACT

A platen includes a holding plate to hold an object and multiple attracted portions disposed at multiple corners of the holding plate. The multiple attracted portions are attractable to a stage of a liquid discharge apparatus by magnetic force.

### CROSS-REFERENCE TO RELATED APPLICATION

This patent application is based on and claims priority pursuant to 35 U.S.C. § 119(a) to Japanese Patent Application No. 2023-170021, filed on Sep. 29, 2023, in the Japan Patent Office, the entire disclosure of which is hereby incorporated by reference herein.

### BACKGROUND

### Technical Field

Embodiments of the present disclosure relate to a platen, a liquid discharge apparatus, and a fixing member.

### RELATED ART

As an image forming apparatus, a digital to garment or direct to garment (DTG) printer is known in the art. Such a DTG printer directly applies ink to a recording medium such as a T-shirt to form an image thereon.

### SUMMARY

Embodiments of the present disclosure describe an improved platen that includes a holding plate to hold an object and multiple attracted portions disposed at multiple corners of the holding plate. The multiple attracted portions are attractable to a stage of a liquid discharge apparatus by magnetic force.

According to another embodiment of the present disclosure, there is provided a fixing member including a magnet to attract a platen via a stage of a liquid discharge apparatus by magnetic force. The magnet is detachably attachable to the stage.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus according to an embodiment of the present disclosure, with covers closed;

FIG. 2 is a plan view of the liquid discharge apparatus of FIG. 1;

FIG. 3 is a perspective view of the liquid discharge apparatus of FIG. 1 with the covers open;

FIG. 4 is a plan view of the liquid discharge apparatus of FIG. 3;

FIG. 5A is a schematic cross-sectional view of a support according to an embodiment of the present disclosure;

FIG. 5B is a schematic plan view of the support of FIG. 5A;

FIG. 6A is a schematic cross-sectional view (or a schematic side view) of a placement member illustrated in FIG. 5A;

FIG. 6B is a schematic plan view of the placement member of FIG. 6A;

FIG. 7A is a schematic cross-sectional view of another support according to an embodiment of the present disclosure;

FIG. 7B is a schematic plan view of the support of FIG. 7A;

FIG. 8 is a schematic cross-sectional view of another support according to an embodiment of the present disclosure;

FIGS. 9A and 9B are schematic plan views of another support according to an embodiment of the present disclosure;

FIGS. 10A and 10B are schematic plan views of another support according to an embodiment of the present disclosure;

FIGS. 11A to 11C are schematic cross-sectional views of another support according to an embodiment of the present disclosure; and

FIG. 12 is a schematic plan view of another support according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A support (i.e., a platen), a liquid discharge apparatus, and a fixing member according to embodiments of the present disclosure are described below with reference to the accompanying drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

A support according to an embodiment of the present disclosure is a support used in a liquid discharge apparatus including a placement member on which a print target is placed. The support is fixable to the placement member by a fixing member detachably attachable to the placement member. The support is fixable to the placement member while supporting the print target. When the fixing member fixes the support to the placement member by magnetic force, and the support is fixed to the placement member, the support and the fixing member are in noncontact with each other.

A digital to garment or direct to garment (DTG) printer includes a stage and a base. The stage is typically attached to the base. The stage or the base is provided with an attachment for attaching the stage to the base. When a support or a T-shirt extension according to a comparative technique is used, the stage is detached, and the attachment of the support or the attachment of the T-shirt extension is fit into the attachment of the base. However, the position and shape of such an attachment are typically different for each manufacturer, and thus usable apparatuses are limited.

As described above, the DTG printer includes the stage (also referred to as a placement table, a placement member, or a platen). An object on which an image is printed (also referred to as a print target or a recording medium) is placed on the stage, and the DTG printer applies ink to the object while moving the stage in some cases. In a comparative example, the DTG printer typically includes a plate-shaped stage which is rectangular in shape. In the DTG printer in the comparative example, a recording medium is directly placed on the stage, or the recording medium such as a T-shirt is placed on the stage with the stage inserted into the inside of the recording medium.

When a garment such as a T-shirt is selected as a recording medium, and for example, an image is printed on a polyester fabric of the recording medium having a large gap between fibers thereof or an image is printed on the recording medium with white ink, the ink may permeate through the fibers from the print face to the back face of the recording medium, causing ink bleed-through on the back face. To prevent such ink bleed-through, the recording medium such as the T-shirt is placed on the stage with the stage inserted into the inside of the recording medium.

However, in the DTG printer in the comparative example, it is difficult to accurately place a recording medium, in particular, a garment such as a T-shirt, on the stage. Thus, the garment such as the T-shirt may be skewed or twisted on the stage. Further, when the T-shirt is larger than the stage, part of the fabric of the T-shirt extends off the stage on the left and right sides. Thus, the center of the T-shirt is likely to be misaligned with the center of the stage. Accordingly, an image may be misaligned with an accurate print position or may be obliquely printed on the recording medium (e.g., T-shirt). It is difficult for even a skilled operator to accurately place a recording medium, in particular, a garment such as a T-shirt, on the stage, and thus the skilled operator may fail to accurately place the recording medium on the stage.

To prevent a print error due to such inaccurate placement of the recording medium, a technique has been considered in which the recording medium such as a T-shirt can reliably be placed at an accurate position.

According to one aspect of the present disclosure, the platen can be provided which is attachable to a stage of an apparatus, without replacing the stage. In an embodiment of the present disclosure, attachment/detachment between the support and the placement member (e.g., a stage or a platen) of the apparatus is performed by magnetic force, and thus the stage can be added, extended, or changed without replacing the stage included in the apparatus. The support of an embodiment of the present disclosure is mountable as it is by providing a fixing member for the stage of, for example, an existing DTG printer. The attachment/detachment by magnetic force may be referred to as an attachment/detachment mechanism by magnetic force or a magnetic attachment/detachment method. The support of an embodiment of the present disclosure is simply fixable to an existing apparatus including a placement member and is detachably attached (fixed) to the placement member. Thus, the support may be referred to as, for example, an additional stage or an additional platen.

A liquid discharge apparatus of an embodiment of the present disclosure includes a placement member, a fixing member, and the support (platen) of an embodiment of the present disclosure. The placement member included in the liquid discharge apparatus of an embodiment of the present disclosure allows a recording medium to be placed on the placement member. The fixing member included in the liquid discharge apparatus of an embodiment of the present disclosure fixes the support to the placement member by magnetic force.

The liquid discharge apparatus of an embodiment of the present disclosure can serve as, for example, an image forming apparatus, a printer, a recording apparatus, or an inkjet printer. The liquid discharge apparatus of an embodiment of the present disclosure can also serve as, for example, a DTG printer.

A fixing member according to an embodiment of the present disclosure is a fixing member to fix a support to a placement member included in a liquid discharge apparatus. The support supports a print target. The print target is placed on the placement member. The support is fixable to the placement member while supporting the print target. The fixing member is detachably attachable to the placement member. When the fixing member fixes the support to the placement member by magnetic force, and the support is fixed to the placement member, the fixing member is in noncontact with the support.

Embodiments of the present disclosure are described below with reference to the drawings. In the drawings, like reference signs denote like elements, and overlapping descriptions may be simplified or omitted as appropriate.

A print target, an object, and a recording medium are synonymous with each other. In the following description, the term “recording medium” will be used.

A liquid discharge apparatus including a support of an embodiment of the present disclosure and a liquid discharge apparatus of an embodiment of the present disclosure are not limited to the following examples. Examples of a liquid discharge apparatus include a DTG printer and a three-dimensional (3D) printer. A support of an embodiment of the present disclosure is mountable as it is to a stage included in a liquid discharge apparatus, without replacing the stage.

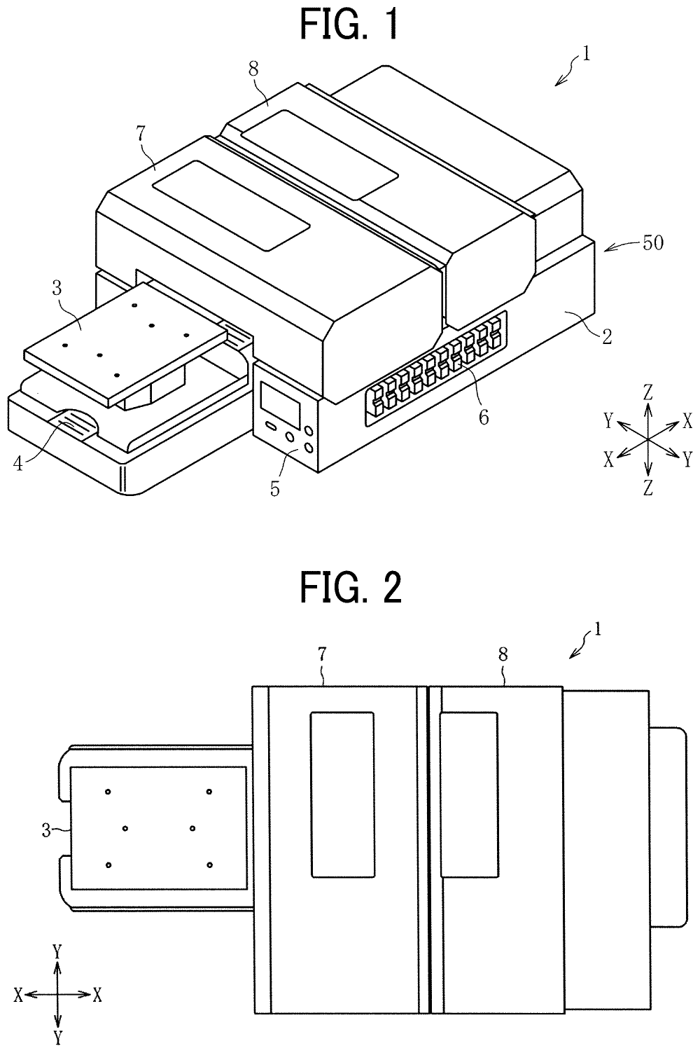

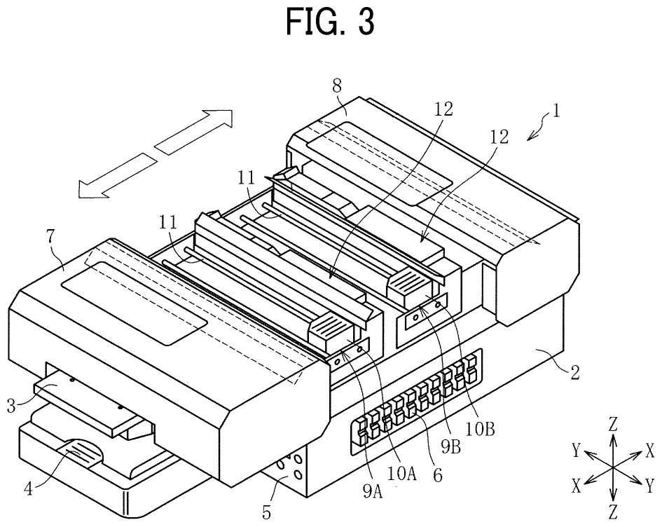

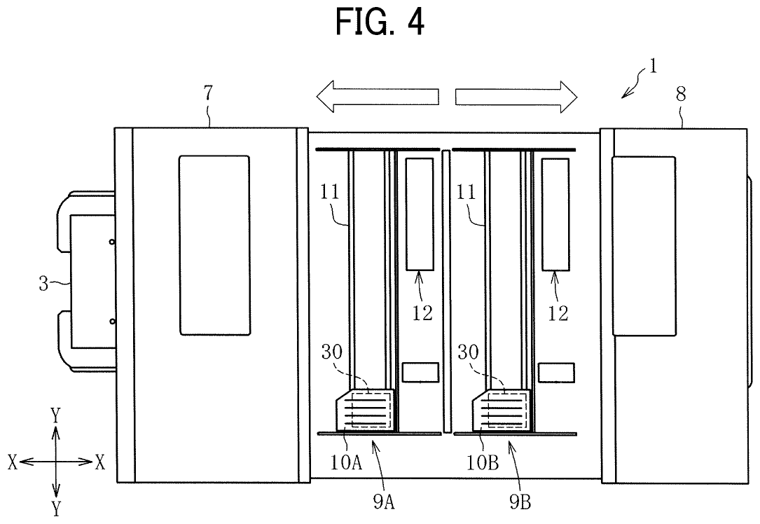

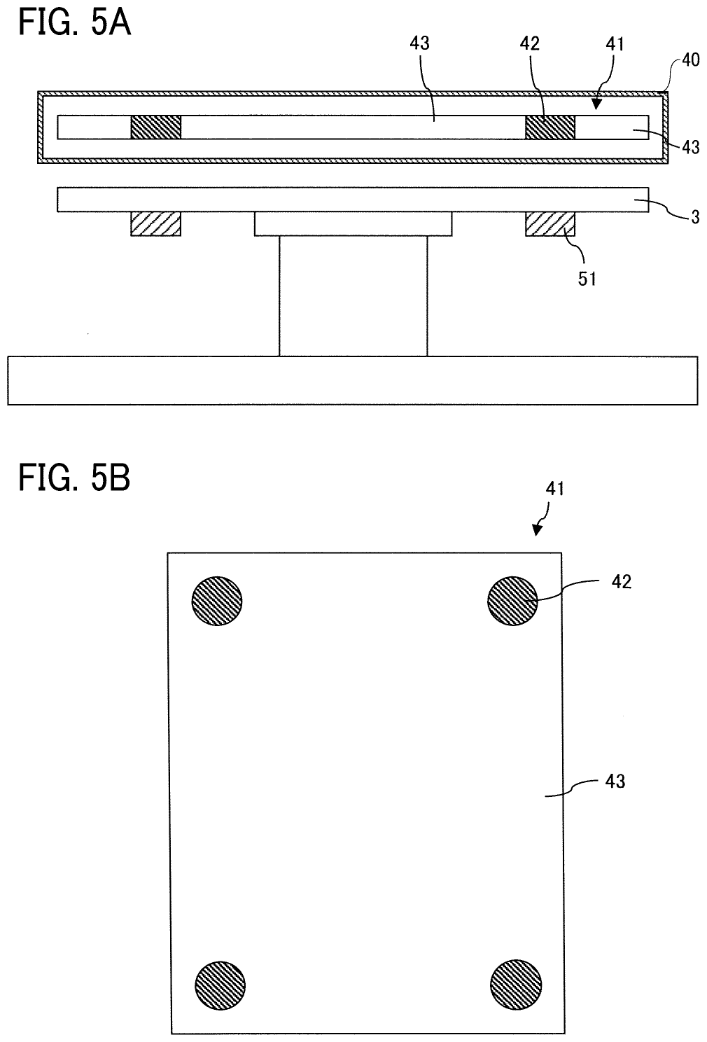

FIG. 1 is a perspective view of a liquid discharge apparatus 1 according to an embodiment of the present disclosure, with covers closed, and FIG. 2 is a plan view thereof. FIG. 3 is a perspective view of the liquid discharge apparatus 1 of FIG. 1, according to the present embodiment, with the covers open, and FIG. 4 is a plan view thereof. Directions X in FIG. 1 are the front-rear direction, sub-scanning direction, and recording-medium conveyance direction of the liquid discharge apparatus 1. Directions Y in FIG. 1 are the transverse direction and main scanning direction of the liquid discharge apparatus 1. Directions Z in FIG. 1 are the vertical directions of the liquid discharge apparatus 1. The directions X and the directions Y are parallel to a surface, onto which a liquid is discharged, of a recording medium on a stage 3, but may have some error. The directions X, Y, and Z are orthogonal to each other.

As illustrated in FIGS. 1 and 2, the liquid discharge apparatus 1 includes the stage 3 in front of a housing 2. The stage 3 is mounted on a guide rail 4. The guide rail 4 extends in the directions X. A control panel 5 is disposed on the front face of the housing 2. An ink cartridge 6 is detachably attached to a side face of the housing 2. A front cover 7 and a rear cover 8 as covers are disposed over the housing 2.

The stage 3 has a flat upper face on which the recording medium is placed. The upper face of the stage 3 is parallel to the directions X and the directions Y The stage 3 moves on the guide rail 4 to reciprocate in both the directions X. The stage 3 is movable up and down in the directions Z. Thus, the height of the recording medium placed on the stage 3 is adjustable.

As described later, an image can be formed with the support of the present embodiment supporting the recording medium and being fixed to the stage 3.

The front cover 7 and the rear cover 8 are movable in both the directions X. In FIG. 1, the front cover 7 has been moved backward and the rear cover 8 has been moved forward to close the front cover 7 and the rear cover 8 (i.e., a closed position). On the other hand, in FIG. 3, the front cover 7 is moved forward and the rear cover 8 is moved backward to open the front cover 7 and the rear cover 8 (i.e., an open position). As described above, the front cover 7 and the rear cover 8 are slidably opened and closed. As a result, an occupied space of the liquid discharge apparatus 1 including an opening and closing space of each of the front cover 7 and the rear cover 8 can be reduced as compared with a configuration in which a front cover and a rear cover are opened and closed in the vertical directions. The front cover 7 and the rear cover 8 have openings at both ends in the front-rear direction. When the front cover 7 and the rear cover 8 are closed, the front cover 7 and the rear cover 8 are continuously arranged in the front-rear direction.

As illustrated in FIGS. 3 and 4, an apparatus body 50 of the liquid discharge apparatus 1 includes, for example, the housing 2 and liquid discharge units 9A and 9B mounted on the housing 2. In the present embodiment, specifically, the apparatus body 50 is a portion of the liquid discharge apparatus 1 other than the front cover 7 and the rear cover 8. The front cover 7 and the rear cover 8 are slidable in the directions X relative to the apparatus body 50.

The front cover 7 and the rear cover 8 are opened to expose the liquid discharge units 9A and 9B to the outside of the liquid discharge apparatus 1. When the liquid discharge units 9A and 9B are exposed to the outside, an operator can clean a maintenance unit 30, the liquid discharge head, and the surroundings thereof, or can replace carriages 10A and 10B. The front cover 7 and the rear cover 8 are closed during image formation. As a result, the liquid discharge units 9A and 9B are covered by the front cover 7 and the rear cover 8 to block access to operation units such as the carriages 10A and 10B of the liquid discharge units 9A and 9B from the outside. The liquid discharge units 9A and 9B are disposed in the closed space in the front cover 7 or the rear cover 8. Accordingly, a mist of ink (liquid) is prevented from scattering to environs outside the liquid discharge apparatus 1 while the liquid discharge head discharges the ink to the recording medium (i.e., during liquid discharge operation). Further, the liquid discharge units 9A and 9B may include a fan to circulate airflow in the front cover 7 or the rear cover 8 to collect the generated mist of the ink (i.e., ink mist) in the front cover 7 or the rear cover 8.

The liquid discharge apparatus 1 according to the present embodiment includes the two liquid discharge units 9A and 9B arranged side by side in the directions X. The liquid discharge unit 9A discharges color ink and white ink. The liquid discharge unit 9B discharges a pretreatment liquid. The liquid discharged by each of the liquid discharge units 9A and 9B is not limited to the above example, and any liquid of the color ink, the white ink, and the pretreatment liquid may be discharged by each of the liquid discharge units 9A and 9B. In particular, when the recording medium is a fabric, the pretreatment liquid is preferably applied to the recording medium before the image formation using the ink. In other words, one of the liquid discharge units 9A and 9B preferably discharges the pretreatment liquid.

Since the liquid discharge units 9A and 9B have similar configurations, the liquid discharge unit 9A is described below. The liquid discharge unit 9A includes a carriage 10A, a guide rod 11, an electrical component unit 12 including, for example, a board and an electrical component cover, and the maintenance unit 30. The liquid discharge units 9A and 9B and the carriages 10A and 10B may be referred to simply as a liquid discharge unit 9 and a carriage 10, respectively, unless distinguished.

The guide rod 11 extends in the main scanning direction. The carriage 10 is movable in the main scanning direction along the guide rod 11. The carriage 10 includes multiple liquid discharge heads. The maintenance unit 30 is disposed at a position facing the guide rod 11 outside a liquid discharge region on one side in the transverse direction (directions Y).

The maintenance unit 30 includes, for example, a wiping member that cleans a nozzle face of the liquid discharge head and a suction mechanism that sucks the nozzle face. The wiping member may be a wiper made of, for example, rubber, or a web made of, for example, nonwoven fabric.

The process of forming an image on the recording medium by the liquid discharge head is described below. However, the example described below is an example in which the support of the present embodiment is not used.

The recording medium is placed on the stage 3 and conveyed along the guide rail 4. The recording medium is conveyed to a rear side of the liquid discharge apparatus 1, and the pretreatment liquid is applied to the recording medium by the liquid discharge unit 9B. Specifically, while the carriage 10B moves in the main scanning direction along the guide rod 11, the liquid discharge unit 9B discharges the pretreatment liquid from the nozzles of the liquid discharge head to apply the pretreatment liquid to the entire width of the recording medium in the main scanning direction. The application of the pretreatment liquid is repeated at multiple positions in the sub-scanning direction. As a result, the pretreatment liquid is applied to the entire recording medium. After that, the stage 3 moves forward, and the liquid discharge unit 9A discharges the color ink of multiple colors onto the recording medium using a method similar to that of the liquid discharge unit 9B. When white color is printed on the recording medium, for example, the liquid discharge unit 9A discharges the white ink onto the recording medium, the stage 3 moves to the rear side of the liquid discharge unit 9A again, and the liquid discharge unit 9A discharges the color ink onto the recording medium. Thus, an image is formed on the recording medium.

A support according to the present embodiment is described below.

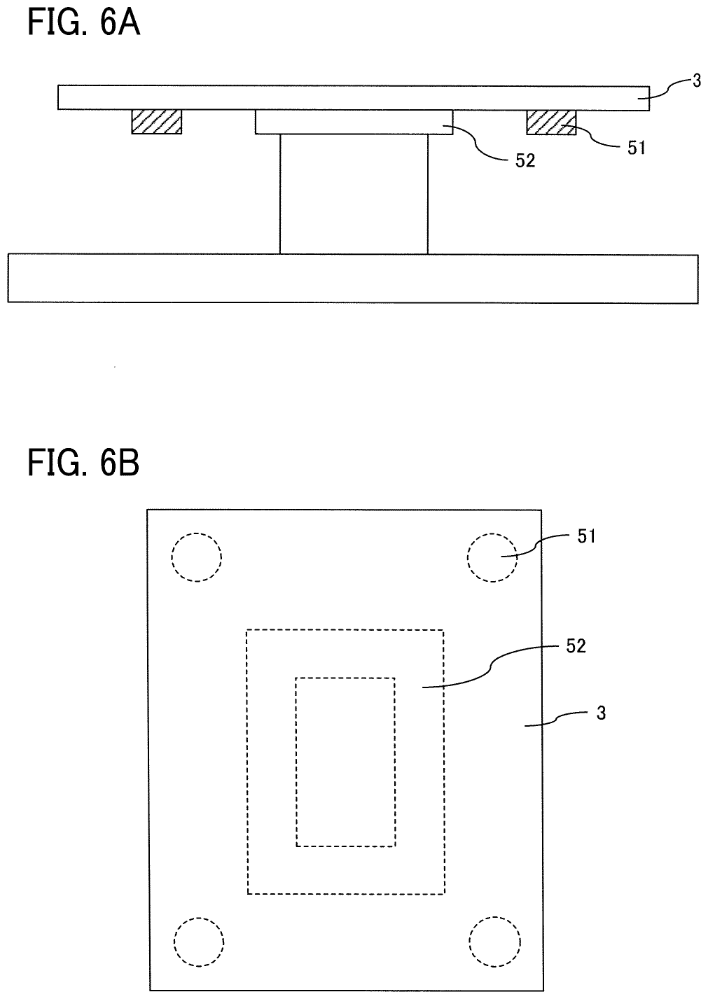

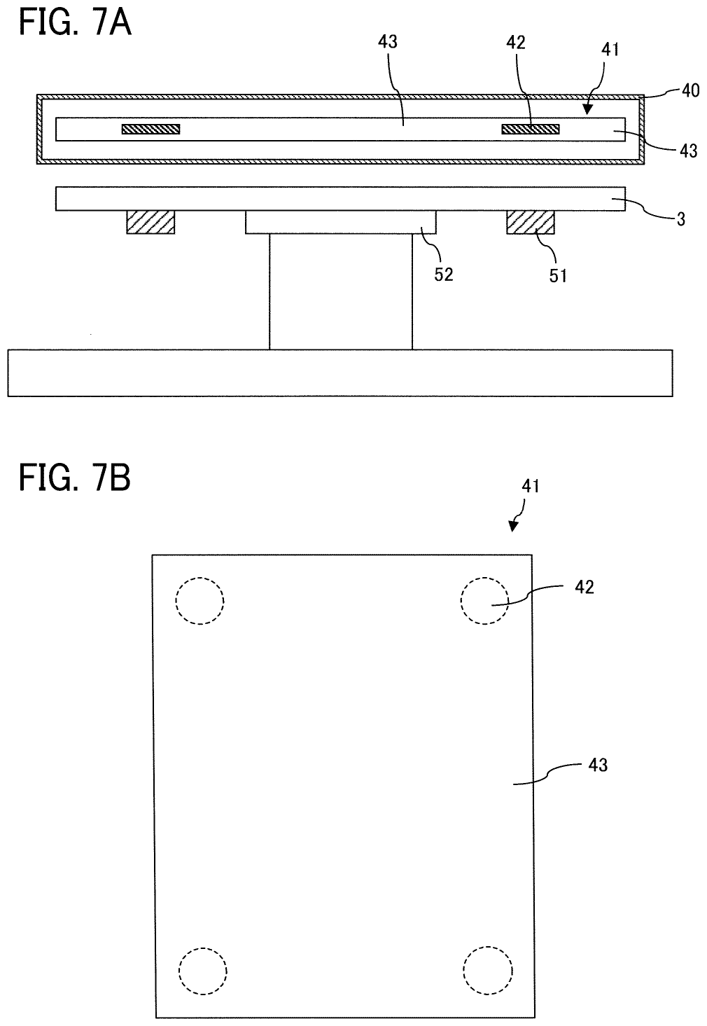

FIGS. 5A and 5B are schematic views of a support 41 (i.e., a platen) fixed to the stage 3, according to the present embodiment. FIG. 5A is a schematic cross-sectional view, and FIG. 5B is a schematic plan view. FIGS. 6A and 6B are schematic views of the stage 3 illustrated in FIGS. 5A and 5B. FIG. 6A is a schematic cross-sectional view or a schematic side view of the stage 3. FIG. 6B is a schematic plan view of the stage 3 when viewed from above.

In the example illustrated in FIGS. 5A and 5B, a T-shirt is used as the recording medium. However, the recording medium in embodiments of the present disclosure is not limited to the T-shirt, and thus other recording media are appropriately selectable. Examples of the recording medium include plain paper, glossy paper, special paper, cloth, a film, an overhead projector (OHP) transparency, and general-purpose print paper. The cloth may be a garment different from the T-shirt, or may be also, for example, a tote bag in addition to the garment. The recording medium may be referred to as, for example, a print medium or a medium.

The support 41 (i.e., the platen) in the present example is fixable to the stage 3 by a magnet 51 provided for the stage 3. The stage 3 is an example of the placement member included in the liquid discharge apparatus. The stage 3 may be referred to as, for example, a stage. The magnet 51 is an example of the fixing member.

The support 41 supports a recording medium 40. Supporting the recording medium 40 may be referred to as, for example, holding the recording medium 40. Further, causing the support 41 to support the recording medium 40 may be referred to as, for example, attaching, setting, or placing the recording medium 40, or may be referred to as causing the support 41 to hold the recording medium 40. The support 41 is fixable to the stage 3 while supporting the recording medium 40. For example, the support 41 is fixed to the stage 3 while supporting a T-shirt. Fixing the support 41 to the stage 3 may be referred to as, for example, mounting, attaching, installing, or setting the support 41 to the stage 3.

The magnet 51 fixes the support 41 to the stage 3 by magnetic force. The magnet 51 is provided for the stage 3. For example, the magnet 51 is attached to the stage 3. Attachment of the magnet 51 to the stage 3 facilitates installation of the magnet 51. The method of installing the magnet 51 is not limited thereto, and thus the magnet 51 may be embedded in the stage 3, or may be installed with, for example, any desired jig. Attachment of the magnet 51 to the stage 3 of an existing apparatus can easily construct the attachment/detachment mechanism by magnetic force.

In the present embodiment, the fixing member (e.g., the magnet 51) is detachably attachable to the placement member (e.g., the stage 3). The timing of attaching the magnet 51 to the stage 3 is appropriately selectable. As in the present example, before the support 41 is attached to the stage 3, the magnet 51 may be attached to the stage 3. Alternatively, the support 41 may be placed on the stage 3, and then the magnet 51 may be attached to the stage 3. The timing of detaching the magnet 51 from the stage 3 is not limited to any particular time, and thus is appropriately selectable.

In the present embodiment, the support 41 is fixable to the stage 3 with the attachment/detachment mechanism by magnetic force, and is detachable from the stage 3. Accordingly, the support 41 is attachable to, for example, a platen or a stage of an existing liquid discharge apparatus. Because the support 41 is fixable to the stage 3, the support 41 may be referred to as, for example, an additional platen or simply as a platen.

In the present embodiment, as illustrated in 5A, when the support 41 is fixed to the stage 3, the support 41 and the magnet 51 (fixing member) are in noncontact with each other. In other words, the magnet attracts the support 41 via the stage 3 to fix the support 41 to the stage 3. Because the support 41 and the magnet 51 (fixing member) are in noncontact with each other, the support 41 can be provided which is attachable to the stage 3 without replacing the stage 3.

As the fixing member, for example, a ferromagnetic member (material) can be used in addition to a magnet. The fixing member is not limited to, for example, any particular number, arrangement, and shape, and thus is appropriately selectable.

An exemplary method of fixing the support 41 to the stage 3 is described below.

The support 41 includes a fixable member (i.e., an attracted portion). For example, the fixable member is attracted to the magnet 51 by magnetic force. The support 41 is simply fixable to the stage 3 by the fixable member.

Examples of the fixable member of the support 41 include a ferromagnetic material and a magnet. When the fixable member is a ferromagnetic material or a magnet, the attachment/detachment mechanism by magnetic force can be simply constructed.

Such a ferromagnetic material is appropriately selectable, and for example, a steel can be used. In the example illustrated in FIGS. 5A and 5B, a steel plate 42 is used as the fixable member.

The steel plate 42 included in the support 41 is attracted, by magnetic force, to the magnet 51 attached to the stage 3. Thus, this action facilitates fixing of the support 41 to the stage 3.

In the support 41 illustrated in FIGS. 5A and 5B, a part different from the steel plate 42 is referred to as a holding part 43 (i.e., a holding plate) in order to distinguish the holding part 43 from the steel plate 42. Although not particularly limited, the holding part 43 supports (holds) a recording medium and holds the steel plate 42.

The holding part 43 can be, for example, a TEFLON-based plate. In this case, a recording medium such as a T-shirt is easily attached to or detached from the support 41. Further, heat resistance can be imparted to the support 41.

The support 41 preferably includes a heat-resistant material. When the support 41 includes the heat-resistant material, the support 41 is detached from the stage 3 after printing, and can be set to a heat presser for pressing while supporting the recording medium. As a result, the support 41 serves as an inner pad, which can prevent ink and the pretreatment liquid from permeating to the back face of the recording medium during the pressing. Further, the support 41 described above is not softened, deformed, or denatured by heating, and thus is continuously usable even if the support 41 is heated.

Such a heat-resistant material is appropriately selectable, and is preferably a material that is not softened, deformed, or denatured even by heating to about 180° C. Examples of the heat-resistant material include fluororesin. Among fluororesin, for example, polytetrafluoroethylene and perfluoroalkoxy alkane are preferable because the support 41 including polytetrafluoroethylene or perfluoroalkoxy alkane can easily carried during attachment and detachment of the support 41. These heat-resistant materials may be used singly or in combination of two or more types thereof.

The form of a heat-resistant material in the support 41 is not particularly limited. Examples of the form include a form in which the surface of the support 41 is coated with a heat resistant material. In addition, for example, the support 41 may be entirely formed of a heat-resistant material. Further, part of the support 41, for example, the holding part 43 may be formed of a heat-resistant material.

The content of the heat-resistant material is not particularly limited, and is preferably 10 mass % or more and 99 mass % or less to the entire mass of the support 41. Further, the content of the heat-resistant material is more preferably 20 mass % or more to the entire mass of the support 41. In this case, the heat resistance of the support 41 is enhanced.

An exemplary case of the support 41 having heat resistance is described below. For example, a T-shirt is manually attached to the support 41, and the support 41 supporting (holding) the T-shirt is fixed to the stage 3. Then, a liquid discharge apparatus discharges liquid such as ink onto the T-shirt to perform printing. After the printing, post-processing may be performed on the T-shirt supported by the support 41. For example, after the printing, the support 41 may be detached from the stage 3, and the T-shirt may be set to a heat presser for pressing while being attached to the support 41. In this case, the support 41 serves as an inner pad, which can prevent, for example, ink and the pretreatment liquid from permeating to the back side of the T-shirt during the pressing.

The fixable member (e.g., the steel plate 42) is appropriately selectable in, for example, disposition, number, and shape. As illustrated in FIGS. 6A and 6B, the stage 3 is typically supported by, for example, a base 52. Thus, the magnet 51 is difficult to be disposed at a portion where the base 52 is positioned. For this reason, the steel plate 42 is preferably disposed in the support 41 while avoiding the portion corresponding to the base 52 of the stage 3.

When the stage 3 is rectangular in plan view, the magnet 51 is preferably disposed at a corner or near the corner of the support 41 from the viewpoint of easy installation. In this case, to stably fix the support 41 to the stage 3, the steel plate 42 is preferably disposed at each of four corners or near each of the four corners of the support 41 (e.g., the holding plate). As described above, the examples illustrated in FIGS. 5A, 5B, 6A, and 6B are preferable examples of the magnet 51 and the steel plate 42. In other words, the steel plate 42 is preferably opposed to the magnet 51 via the stage 3.

In the example illustrated in FIGS. 5A and 5B, the support 41 is fixed to the stage 3 via the recording medium 40 between the support 41 and the stage 3. The recording medium 40 is not particularly limited. However, for example, when the recording medium 40 is a garment such as a T-shirt, the recording medium 40 is supported by the support 41 so as to be fitted around the support 41. In other words, the support 41 is inserted into the inside of the body of the T-shirt, which has a tubular sheet shape, to hold the T-shirt, and the support 41 holding the T-shirt is attached to the stage 3 to sandwich a part of the T-shirt between the support 41 and the stage 3 to fix the T-shirt. Since the support 41 is fixed to the stage 3 via the recording medium 40, the recording medium 40 is prevented from being displaced during printing.

As described above, in the present embodiment, when the support 41 is fixed to the stage 3, the support 41 and the magnet 51 (fixing member) are in noncontact with each other. The term “noncontact” herein means that the support 41 and the magnet 51 are in noncontact with each other when the support 41 supports a recording medium, and the support 41 and the magnet 51 are in noncontact with each other when the support 41 is fixed to the stage 3 while the support 41 does not support the recording medium.

An aspect of providing a fixable member for the support 41 is appropriately selectable. At least part of the fixable member is preferably embedded in the support 41. More specifically, preferably, a part of the fixable member is exposed from a support and another part of the fixable member is embedded in the support, or the fixable member is entirely embedded in the support without being exposed from the support. Since at least part of the fixable member is embedded in the support 41, the fixable member is unlikely to come off the support 41.

The example illustrated in FIGS. 5A and 5B is a case where a part of the steel plate 42 is exposed from the support 41 and the other part thereof is embedded in the support 41. In this case, for example, the steel plate 42 is easily installed in the support 41 and can be visually recognized from the outside. For example, the holding part 43 of the support 41 has a hole or a recess for the steel plate 42, and the steel plate 42 is fitted into the hole or the recess of the holding part 43. Fitting may be referred to as, for example, embedding or engaging. With such a configuration, a support including a fixable member can easily be produced.

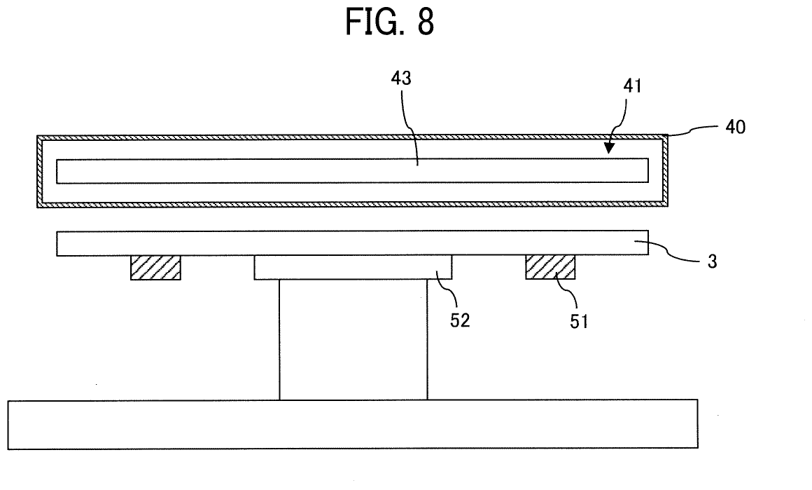

FIGS. 7A and 7B illustrate another embodiment of the present disclosure. FIGS. 7A and 7B are schematic views of a support 41 fixed to the stage 3 according to another embodiment of the present disclosure. FIGS. 7A and 7B are similar to FIGS. 5A and 5B, respectively. FIG. 7A is a schematic cross-sectional view, and FIG. 7B is a schematic plan view.

The example illustrated in FIGS. 7A and 7B is a case where a steel plate 42 is not exposed from the support 41 and is entirely embedded in the support 41. In this case, the steel plate 42 is less likely to come off the support 41.

In the present embodiment, when the support 41 is not fixed to the stage 3 (placement member) and does not support a recording medium, the steel plate 42 (fixable member) in the support 41 is preferably recognizable from the outside of the support 41 to locate the position of the steel plate 42. Since the position of the steel plate 42 can be recognized from the outside of the support 41, workability when the support 41 is fixed to the stage 3 can be enhanced. For example, because the support 41 is fixable to the stage 3 while the position of the steel plate 42 is recognized, an error in the fixing position of the support 41 can be prevented.

The method of recognizing the position of the steel plate 42 (fixable member) from outside the support 41 is appropriately selectable. Some examples are described below.

As in the example illustrated in FIGS. 5A and 5B, when a part of the steel plate 42 is exposed from the support 41, examples of the method of recognizing the steel plate 42 include changing the color of the surface of a portion where the steel plate 42 is exposed (also referred to as, for example, an exposed portion), changing of a material of the exposed portion, and changing texture of the surface of the exposed portion. By changing (making different) the surface of the exposed portion of the steel plate 42 in color from a holding part 43, the position of the steel plate 42 can be visually recognized to locate the position of the steel plate 42 from the outside. Further, by changing (making different) the exposed portion of the steel plate 42 in texture from the holding part 43, the position of the steel plate 42 can be recognized from the outside by touching the exposed portion of the steel plate 42.

As described above, the method of positional recognition of the steel plate 42 from the outside is not limited to visual recognition, and for example, includes touching. The positional recognition of the steel plate 42 from the outside may be expressed as positional estimation of the steel plate 42 from the outside.

In addition to the methods described above, a part or the entirety of the holding part 43 of the support 41 may be made of, for example, a transparent material such that the steel plate 42 can be visually recognized from the outside.

The method of changing the color of the surface of the exposed portion of the steel plate 42 is not particularly limited. For example, a colorant may be used, or the material of the exposed portion may be appropriately changed. In addition to these methods, the holding part 43 of the support 41 may be different in color from the steel plate 42. The method of changing the texture of the exposed portion of the steel plate 42 is not particularly limited. For example, the exposed portion of the steel plate 42 may be subjected to processing such as polishing, may have an unevenness, or may have an uneven shape serving as a mark.

As in the example illustrated in FIGS. 7A and 7B, when the steel plate 42 is embedded in the support 41, i.e., when the steel plate 42 is not exposed, the following examples are considered. For example, a portion or the entirety of the holding part 43 of the support 41 is made of a transparent material such that the steel plate 42 can be visually recognized from the outside. A portion where the inside of the support 41 can be visually recognized may be referred to as, for example, a transparent portion. The transparent portion of the support 41 may be, for example, transparent or substantially transparent. The transparent portion may be colored as long as the steel plate 42 can be visually recognized from outside the support 41 through the transparent portion.

The above description in the case where the steel plate 42 is exposed is also applicable to the case where the steel plate 42 is embedded in the support 41. For example, the color or the texture of the holding part 43 corresponding to the position where the steel plate 42 is embedded may be changed (made different) from the color or the texture of the holding part 43 corresponding to the position where the steel plate 42 is not embedded. With such an arrangement, even when the steel plate 42 is embedded in the support 41, the position of the steel plate 42 is recognizable from the outside.

Another embodiment of the present disclosure is described below. Descriptions of items similar to the items of the above-described embodiment are omitted.

In the embodiment described above, the magnet 51 is attached to the stage 3, and then the support 41 is fixed to the stage 3. In the present embodiment, an example will be described in which a support 41 is fixed to a stage 3, and then a magnet 51 is attached to the stage 3.

As described above, a fixing member (e.g., the magnet 51) is detachably attachable to a placement member (e.g., the stage 3), and the timing of attaching the magnet 51 to the stage 3 is appropriately selectable. After the support 41 is placed on the stage 3, the magnet 51 may be attached to the stage 3 to fix the support 41 to the stage 3.

Another embodiment of the present disclosure is described below.

In the embodiment described above, the form in which the support includes the fixable member has been described. Embodiments of the present disclosure, however, is not limited to the embodiment described above, and thus includes a case where the support does not include the fixable member. The present embodiment is described below. Descriptions of items similar to the items of the above-described embodiment are omitted.

In the present embodiment, a support does not include a fixable member, and for example, the support itself is fixed to the placement member by magnetic force of a fixing member attached to the placement member.

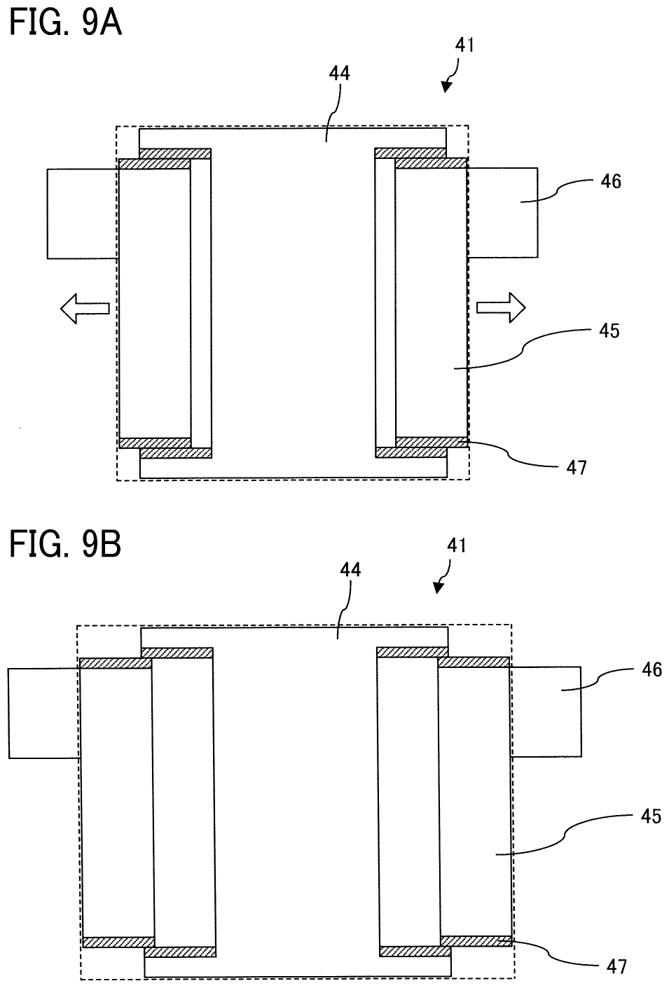

FIG. 8 is a schematic view of a support 41 fixed to the stage 3 according to the present embodiment. FIG. 8 is similar to FIG. 5A. To fix the support 41 to the stage 3 without a fixable member, a holding part 43 of the support 41 includes a ferromagnetic material or a magnet. With this configuration, the support 41 itself is fixed to the stage 3. In other words, a part of the holding part 43 of the support 41 serves as a fixable member.

Yet another embodiment of the support is described below.

In the embodiment described above, the support 41 is rectangular in plan view. The present disclosure is not limited to the embodiment described above, and for example, the shape of the support 41 may be appropriately changed. An example of such a change is described below.

A support 41 according to the present embodiment includes a body (which correspond to the holding part 43 in the above embodiment), an extensible part, and a foldable part. The extensible part is connected to the body and is extensible and retractable in the in-plane direction of the body. The foldable part is connected to the extensible part and is foldable in an intersecting direction intersecting the in-plane direction. In this case, a recording medium different in size can be supported by the support 41, and slack and misalignment of the recording medium can be reduced when the recording medium is supported by the support 41.

For example, the support 41 is inserted into a recording medium such as a T-shirt, and the extensible part is extended or retracted to adjust the support 41 to the size of the recording medium. Then, the foldable part is folded to apply tension to the recording medium. As a result, slack and misalignment of the recording medium can be reduced.

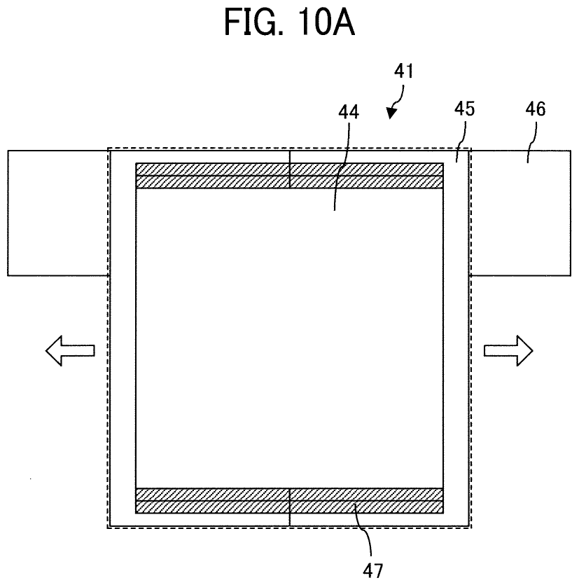

FIGS. 9A and 9B are schematic plan views of the support 41 according to the present embodiment. FIG. 9A illustrates the extensible part which is retracted. FIG. 9B illustrates the extensible part which is extended. As illustrated in FIGS. 9A and 9B, the support 41 of the present example includes a body 44 (i.e., the holding plate), an extensible part 45, and a foldable part 46. The blank arrows in FIG. 9A schematically indicate the directions to extend the extensible part 45. The extensible part 45 is extensible and retractable in the in-plane direction of the body 44.

The broken line in FIGS. 9A and 9B corresponds to the body of the T-shirt. The foldable part 46 corresponds to a sleeve of the T-shirt.

The method of extending or retracting the extensible part 45 is not particularly limited, and thus is appropriately selectable. As in the example illustrated in FIGS. 9A and 9B, slide rails 47 may be attached to the inside of the body 44 and the extensible part 45 to pull out the extensible part 45 from the body 44.

A stopper for fixing the extensible part 45 may be provided in order to prevent misalignment after the recording medium is set to the support 41 or during printing. The stopper allows the extensible part 45 to be fixed while being fully extended, and further allows the extensible part 45 to be fixed at any desired position. As the stopper, a known stopper can be used. Further, the extensible part 45 may be extended stepwise.

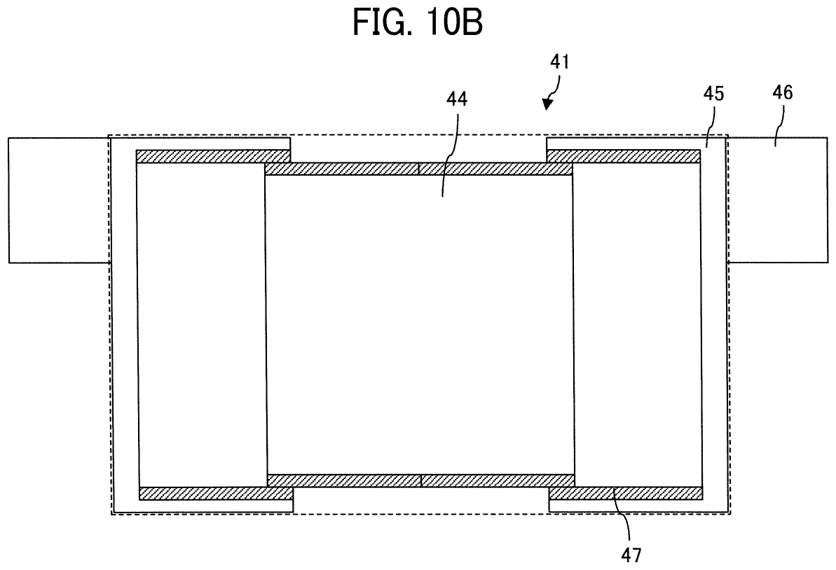

FIGS. 10A and 10B are schematic plan views of the support 41 according to the present embodiment. FIGS. 10A and 10B are similar to FIGS. 9A and 9B, respectively. The configurations of the body 44 and the others are not limited to the example illustrated in FIGS. 9A and 9B, and thus are appropriately selectable. In the example illustrated in FIGS. 10A and 10B, slide rails 47 are attached to the outside of a body 44 and an extensible part 45 to pull out the extensible part 45 from the body 44.

The broken line in FIGS. 10A and 10B corresponds to the body of the T-shirt. The foldable part 46 corresponds to a sleeve of the T-shirt.

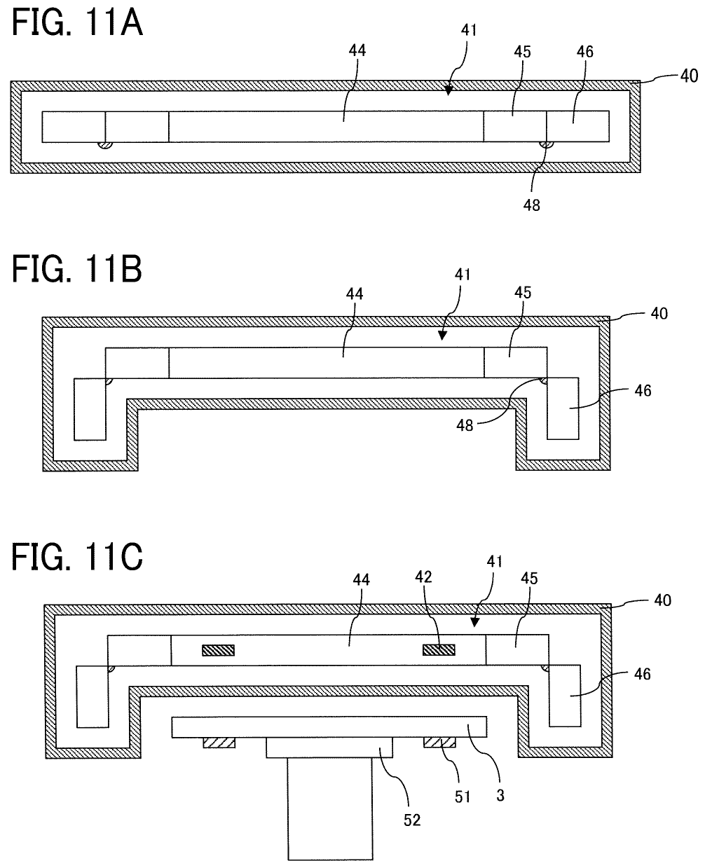

FIGS. 11A, 11B, and 11C are schematic cross-sectional views or schematic side views of the support 41, illustrating the foldable part 46 of the support 41 according to the present embodiment. FIG. 11A illustrates the foldable part 46 before being folded. FIG. 11B illustrates the foldable part 46 after being folded. FIG. 11C is a schematic cross-sectional view of the support 41 fixed to the stage 3.

The extensible part 45 is extensible and retractable in the in-plane direction of the body 44. Thus, after the support 41 is inserted into the recording medium 40 (e.g., a T-shirt), the extensible part 45 can be extended in accordance with the size of the recording medium 40. As illustrated in FIGS. 11A and 11B, the extensible part 45 and the foldable part 46 are connected by a hinge 48. After the support is inserted into the recording medium 40, the foldable part 46 is manually foldable in the intersecting direction (e.g., downward). As described above, the support 41 supports the recording medium 40 in such a manner. As a result, slack and misalignment of the recording medium 40 can be reduced.

As illustrated in FIG. 11C, the support 41 of the present embodiment is fixable to the stage 3 with the foldable part 46 folded. The support 41 illustrated in FIG. 11C includes a steel plate 42 (fixable member). In the present embodiment, the disposition of the steel plate 42 is appropriately selectable, and for example, the steel plate 42 can be disposed in the body 44.

Another support according to the present embodiment is described below.

A support 41 may have, for example, a T-shirt shape. This shape facilitates setting of a T-shirt on the support 41, resulting in enhancement of the work efficiency. An extensible part 45 is adjustable to the size of the T-shirt (e.g., S, M, or L). A setting error such as misalignment of the center of the T-shirt and twist of the body of the T-shirt can be prevented, and thus an image can be printed at a desired position of the T-shirt. Printing can be performed with the T-shirt set on the support 41 and the support 41, which is supporting the T-shirt, fixed to the stage 3. Further, post-processing can be performed with the T-shirt set on the support 41 after the printing.

In the present example, the support 41 has a T-shirt shape, the body 44 and the extensible part 45 correspond to the body of the T-shirt, and the foldable part 46 corresponds to a sleeve of the T-shirt. However, part of the extensible part may correspond to part of the sleeve of the T-shirt.

The sleeve and the body serve as guides for setting the T-shirt. The T-shirt can be easily set at an accurate position. As a result, deviation of the printing position due to a setting error can be prevented. When a platen is not foldable and remains in the T-shirt shape, the platen occupies a space corresponding to the width of the sleeves extending to the left and right on the stage. However, in the support 41 of the present example, the sleeves are foldable during printing, which prevents the increase of an apparatus in size.

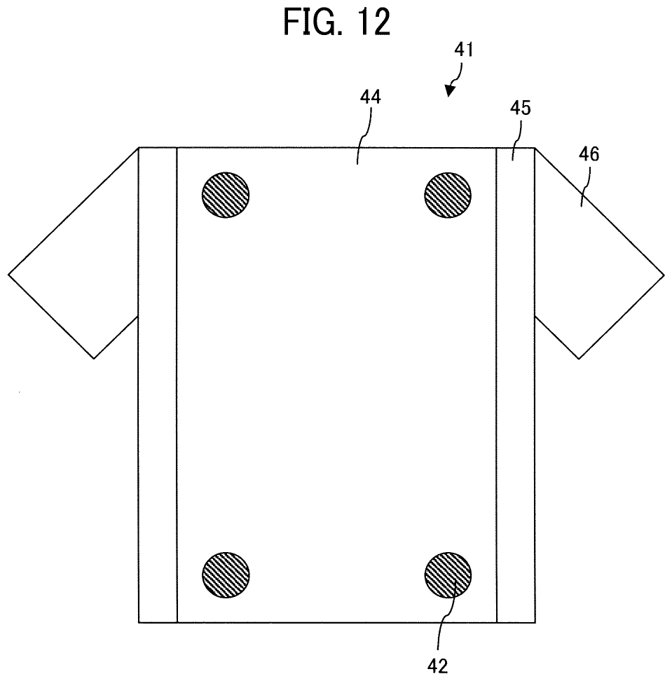

FIG. 12 is a schematic plan view of the support 41 in the present example. In the present example, the support 41 has a T-shirt shape in plan view, the body 44 and the extensible part 45 correspond to the body of the T-shirt, and the foldable part 46 corresponds to a sleeve of the T-shirt. Also in the support 41 of the present example, as illustrated in FIGS. 11A to 11C, the foldable part 46 is manually foldable in the intersecting direction (e.g., downward).

The body 44 is rectangular in plan view. Steel plates 42 are disposed at near four corners of the body 44, respectively. In the support 41 of the present example, the steel plates 42 are exposed from the surface of the support 41.

Also in the present example, the following can be performed. A T-shirt is fitted around the support 41, and the extensible part 45 is extended in accordance with the size of the T-shirt. Then, the foldable part 46 corresponding to the sleeve of the T-shirt is folded downward. After that, the support 41 is fixed to the stage 3 to start printing.

The body 44, the extensible part 45, and the foldable part 46 serve as guides for setting the T-shirt. The T-shirt can be easily set at the accurate position, resulting in prevention of deviation of the printing position due to a setting error. Further, the sleeve is foldable during printing, which prevents the increase of an apparatus in size.

The present example is not limited to the above, and thus the T-shirt may be placed on the support 41 for printing without being fitted around the support 41. In this case, if the foldable part 46 is folded downward from the beginning, the support 41 can be used in a manner similar to the manner for a comparative platen. Even for printing on a recording medium other than a T-shirt, such as a bag, the recording medium can be placed on the support 41 for printing without being fitted around the support 41.

The body 44, the extensible part 45, and the foldable part 46 are not particularly limited in material, but preferably include, for example, a heat-resistant material. In this case, as described above, post-processing such as pressing by a heat presser can be performed after the printing. Further, the post-processing is enhanced in work efficiency.

As illustrated in the embodiment described above, the support 41 preferably include the single body 44, the two extensible parts 45, and the two foldable parts 46. In this case, a T-shirt can be easily set onto the support 41 at the accurate position.

Aspects of the present disclosure are, for example, as follows.

### Aspect 1

A support is a support used in a liquid discharge apparatus including a placement member on which a print target is placed. The support is fixable to the placement member by a fixing member detachably attachable to the placement member. The support is fixable to the placement member while supporting the print target. When the fixing member fixes the support to the placement member by magnetic force, and the support is fixed to the placement member, the support and the fixing member are in noncontact with each other.

In other words, a platen includes a holding plate to hold an object and multiple attracted portions disposed at multiple corners of the holding plate. The multiple attracted portions are attractable to a stage of a liquid discharge apparatus by magnetic force.

### Aspect 2

The support according to Aspect 1 includes a fixable member including a ferromagnetic member or a magnet.

In other words, the multiple attracted portions include a ferromagnetic material or a magnet.

### Aspect 3

In the support according to Aspect 2, part of the fixable member is exposed from the support and another part of the fixable member is embedded in the support, or the fixable member is entirely embedded in the support without being exposed from the support.

In other words, a part of each of the multiple attracted portions is exposed from the holding plate, and another part of each of the multiple attracted portions is embedded in the holding plate.

Alternatively, all parts of the multiple attracted portions are embedded in the holding plate and not exposed from the holding plate.

### Aspect 4

In the support according to Aspect 3, with the support not fixed to the placement member and not supporting the print target, a position of the fixable member disposed in the support is checkable from outside the support.

In other words, positions of the multiple attracted portions in the holding plate are recognizable from an exterior of the holding plate.

### Aspect 5

The support according to any one of Aspects 1 to 4, further includes a body, an extensible part connected to the body, and a foldable part connected to the extensible part. The extensible part is lengthen or shorten in a plane direction of the body. The foldable part is foldable.

In other words, the platen according to any one of Aspects 1 to 4, further includes an extensible part coupled to the holding plate. The extensible part is extensible in an in-plane direction of the holding plate.

In addition, the platen further includes a foldable part coupled to the extensible part. The foldable part is foldable relative to the extensible part in an intersecting direction intersecting the in-plane direction of the holding plate.

### Aspect 6

In the support according to Aspect 5, the support has a planer shape corresponding to a shape of a T-shirt, the body and the extensible part correspond to a body of the T-shirt, and the foldable part corresponds to a sleeve of the T-shirt.

In other words, the holding plate, the extensible part, and the foldable part form a T-shirt shape. The holding plate and the extensible part correspond to a body of the T-shirt shape, and the foldable part corresponds to a sleeve of the T-shirt shape.

### Aspect 7

The support according to any one of Aspects 1 to 6, includes a heat-resistant material.

In other words, the holding plate and the multiple attracted portions include a heat-resistant material.

### Aspect 8

A liquid discharge apparatus includes the placement member, the fixing member, and the support according to any one of Aspects 1 to 7.

In other words, a liquid discharge apparatus includes the platen according to any one of Aspects 1 to 7, the stage to which the platen is attached, a fixing member to attract the platen via the stage by magnetic force, and a liquid discharge unit to discharge a liquid onto the object.

In addition, the fixing member is opposed to the multiple attracted portions via the stage.

Further, the platen is inserted into the object having a tubular sheet shape to hold the object, and the platen is attached to the stage to sandwich a part of the object between the platen and the stage to fix the object.

### Aspect 9

A fixing member is a fixing member to fix a support to a placement member included in a liquid discharge apparatus. The support supports a print target. The print target is placed on the placement member. The support is fixable to the placement member while supporting the print target. The fixing member is detachably attachable to the placement member. When the fixing member fixes the support to the placement member by magnetic force, and the support is fixed to the placement member, the fixing member is in noncontact with the support.

In other words, a fixing member includes a magnet to attract a platen via a stage of a liquid discharge apparatus by magnetic force. The magnet is detachably attachable to the stage.

As another aspect, in the platen according to Aspect 1, the holding plate is rectangular, each of the multiple attracted portions is circular, and the multiple attracted portions are respectively disposed at four corners of the holding plate.

As described above, according to one aspect of the present disclosure, the platen can be provided which is attachable to a stage of an apparatus, without replacing the stage.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A platen comprising:
a holding plate to hold an object; and
multiple attracted portions disposed at multiple corners of the holding plate, the multiple attracted portions attractable to a stage of a liquid discharge apparatus by magnetic force.

2. The platen according to claim 1,
wherein the multiple attracted portions include a ferromagnetic material or a magnet.

3. The platen according to claim 2,
wherein a part of each of the multiple attracted portions is exposed from the holding plate, and
another part of each of the multiple attracted portions is embedded in the holding plate.

4. The platen according to claim 2,
wherein all parts of the multiple attracted portions are embedded in the holding plate and not exposed from the holding plate.

5. The platen according to claim 3,
wherein positions of the multiple attracted portions in the holding plate are recognizable from an exterior of the holding plate.

6. The platen according to claim 4,
wherein positions of the multiple attracted portions in the holding plate are recognizable from an exterior of the holding plate.

7. The platen according to claim 1,
wherein the holding plate is rectangular,
each of the multiple attracted portions is circular, and
the multiple attracted portions are respectively disposed at four corners of the holding plate.

8. The platen according to claim 1, further comprising an extensible part coupled to the holding plate, the extensible part extensible in an in-plane direction of the holding plate.

9. The platen according to claim 8, further comprising a foldable part coupled to the extensible part, the foldable part foldable relative to the extensible part in an intersecting direction intersecting the in-plane direction of the holding plate.

10. The platen according to claim 9,
wherein the holding plate, the extensible part, and the foldable part form a T-shirt shape,
the holding plate and the extensible part correspond to a body of the T-shirt shape, and
the foldable part corresponds to a sleeve of the T-shirt shape.

11. The platen according to claim 1,
wherein the holding plate and the multiple attracted portions include a heat-resistant material.

12. A liquid discharge apparatus comprising:
the platen according to claim 1;
the stage to which the platen is attached;
a fixing member to attract the platen via the stage by the magnetic force; and
a liquid discharge unit to discharge a liquid onto the object.

13. The liquid discharge apparatus according to claim 12,
wherein the fixing member is opposed to the multiple attracted portions via the stage.

14. The liquid discharge apparatus according to claim 12,
wherein the platen is inserted into the object having a tubular sheet shape to hold the object, and
the platen is attached to the stage to sandwich a part of the object between the platen and the stage to fix the object.

15. A fixing member comprising:
a magnet to attract a platen via a stage of a liquid discharge apparatus by magnetic force, the magnet detachably attachable to the stage.
